(19) United States
(12) Patent Application Publication
(10) Pub. No.: US 2017/0190367 A1
(43) Pub. Date: Jul. 6, 2017

(54) Track-Type Machine

(71) Applicant: Caterpillar Inc., Peoria, IL (US)

(72) Inventors: Timothy A. Thorson, Morton, IL (US); Robert Meyer, Metamora, IL (US); Gregory J. Kaufmann, Metamora, IL (US); Mark Diekevers, Washington, IL (US); Eric Johannsen, Washington, IL (US)

(73) Assignee: Caterpillar Inc., Peoria, IL (US)

(21) Appl. No.: 14/988,937

(22) Filed: Jan. 6, 2016

(51) Int. Cl. B62D 55/15; B62D 55/06; B62D 55/08; B62D 55/14; B62D 55/088

(52) U.S. Cl. CPC B62D 55/15; B62D 55/14; B62D 55/088; B62D 55/08; B62D 55/06; E02F 3/32

(57) ABSTRACT

A track roller assembly is disclosed. The track roller assembly may include a shaft and a cap engaged with the shaft. The track roller assembly may further include a roller shell configured to rotate about the shaft and may have a through-bore. The track roller assembly may include a crescent-based track roller seal, a toric-based track roller seal or a combination of both the crescent-based track roller seal and the toric-based track roller seal.

### TECHNICAL FIELD

This disclosure generally relates to a track-type machine and, more particularly, to a track roller assembly for a track-type machine.

### BACKGROUND

Track-type machines, such as excavators, bulldozers, track-loaders and skid-steer loaders, are used in a variety of applications. Generally speaking, these machines have an operator station, a power source, an undercarriage and a pair of track systems laterally flanking the machine. Each track system may include a roller frame positioned along a lengthwise-extending direction of the track-type machine and a drive sprocket that is rotatably driven by the power source.

Each track system may also include one or more idler wheels. Further, each track system may typically include one or more upper and/or lower track roller assemblies. These track roller assemblies are located along the lengthwise-extending axis of the roller frame between the sprocket and the one or more idler wheels. Such track systems also include an endless track that circumscribes the drive sprocket, the one or more idler wheels, and the track roller assemblies. The endless track is rotatably engaged with the drive sprocket and transfers the energy of the power source to the ground to thereby provide locomotion to the track-type machine.

The track roller assemblies may include a shaft about which a roller shell having a through-bore may be disposed. The shaft may be fixed in place and the roller shell may rotate about the shaft when the track-type machine is in motion. The track-type machine may operate in adverse environments wherein the track roller assemblies may be exposed to abrasive mixtures of water, dirt, sand, rock or other minerals and even chemical elements. These contaminants may enter a space between the shaft and the through-bore of the roller shell leading to wear. Accordingly, track roller seals may be utilized to exclude the afore-mentioned contaminants, and retain lubricant within the space between the shaft and the through-bore of the roller shell.

Although track roller seals are known, there is still room for improvement. For example, U.S. Pat. No. 6,568,684 (“Bedford”) discloses a method for forming a seal assembly around a shaft. More specifically, Bedford discloses a track roller seal utilizing two seal members engaging at a seal face to limit ingress of contaminants into the track roller and mitigate leakage of lubricant from the track roller. While Bedford is arguably an effective and highly durable design, it may suffer from mud-packing related malfunctions during freeze/thaw cycles experienced during the spring and fall seasons.

The present disclosure is directed to overcoming one or more problems set forth above and/or other problems associated with the prior art.

### SUMMARY

In accordance with one aspect of the present disclosure, a track roller assembly is disclosed. The track roller assembly may include a shaft and a cap engaged with the shaft. The track roller assembly may further include a roller shell configured to rotate about the shaft and may have a through-bore.

In accordance with another aspect of the present disclosure, a track system is disclosed. The track system may include a track roller frame and the track roller frame may be positioned along a lengthwise-extending direction of a track-type machine. Further, the track system may include a drive sprocket and the drive sprocket may be located at a first end of the track roller frame and be rotatably driven by a power source. Moreover, the track system may include a first idler wheel. The first idler wheel may be rotatably associated with the track roller frame. Additionally, the track system may include a shaft and the shaft may be operatively secured to the track roller frame and be immovable relative to the track roller frame. Moving on, the track system may include a cap that is engaged with the shaft and that may be stationary relative to the track roller frame. Furthermore, the track system may include a roller shell. The roller shell may have a through-bore and be configured to rotate about the shaft. Lastly, the track system may include an endless track. The endless track may circumscribe the drive sprocket, the first idler wheel and the roller shell. Furthermore, the endless track may be propelled by the drive sprocket and the endless track may be configured to transfer energy of the power source.

In accordance with another embodiment of the present disclosure, a track-type machine is disclosed. The track-type machine may include an undercarriage and a power source supported by the undercarriage. Additionally, the track-type machine may include a track roller frame and the track roller frame may be positioned along a lengthwise-extending direction of the track-type machine. Further, the track-type machine may include a drive sprocket and the drive sprocket may be located above the track roller frame and be rotatably driven by the power source. Moreover, the track system may include a first idler wheel. The first idler wheel may be rotatably associated with the track roller frame. Additionally, the track-type machine may include a second idler wheel. Moreover, the track-type machine may include a shaft and the shaft may be operatively secured to the track roller frame and be immovable relative to the track roller frame. Moving on, the track-type machine may include a cap that is engaged with the shaft and that may be stationary relative to the track roller frame. Furthermore, the track-type machine may include a roller shell. The roller shell may have a through-bore and be configured to rotate about the shaft. Lastly, the track system may include an endless track. The endless track may circumscribe the drive sprocket, the first idler wheel, the second idler wheel and the roller shell. Furthermore, the endless track may be propelled by the drive sprocket and the endless track may be configured to transfer energy of the power source.

These and other aspects and features of the present disclosure will be more readily understood when read in conjunction with the accompanying drawings.

### BRIEF DESCRIPTION

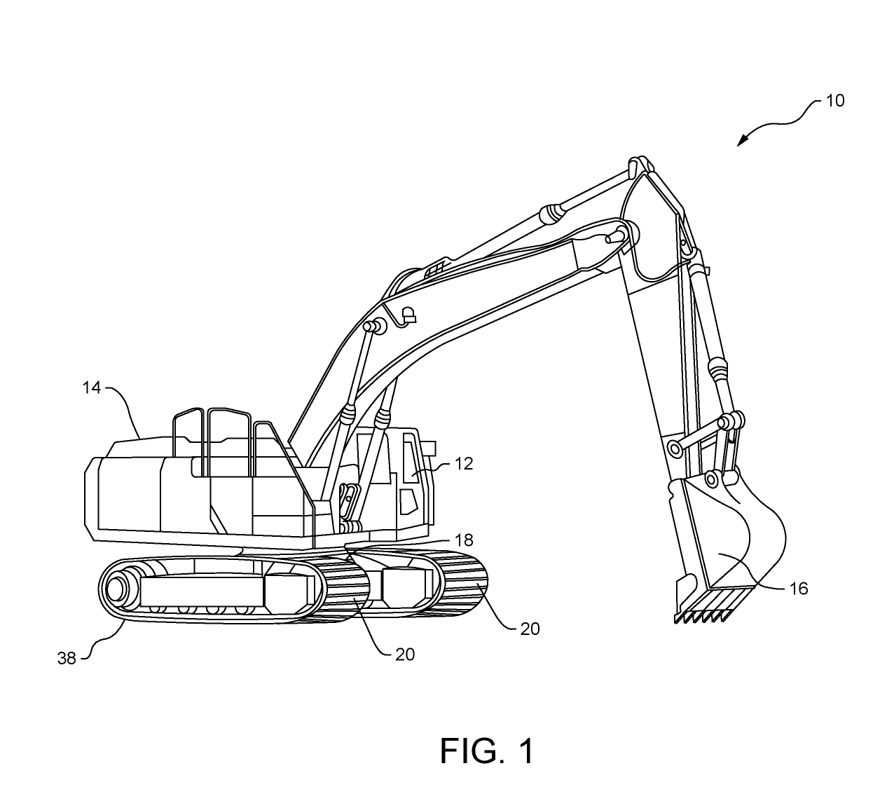

FIG. 1 is side perspective view of a track-type machine manufactured in accordance with the present disclosure.

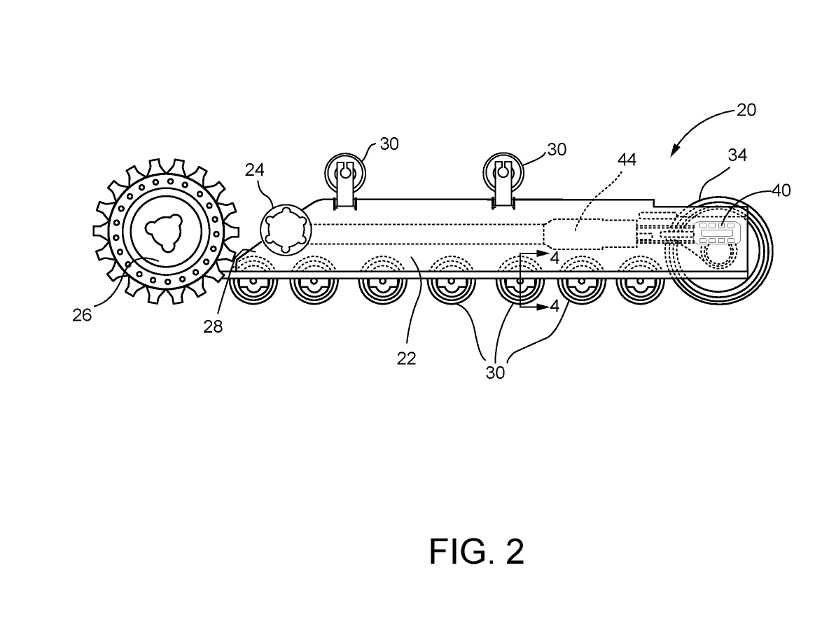

FIG. 2 is a side elevation view of an exemplary track system, without the endless track depicted, that may be used in conjunction with the track-type machine of FIG. 1.

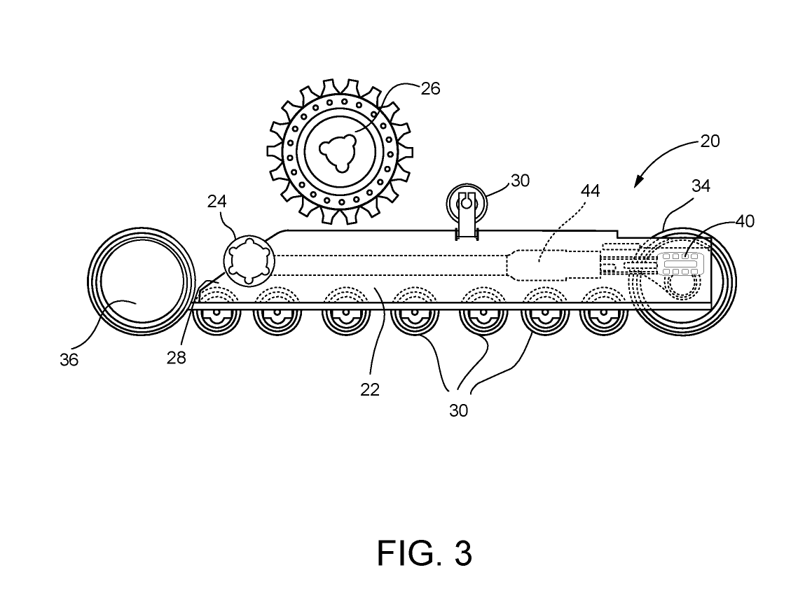

FIG. 3 is a side elevation view of an alternative exemplary track system, also without the endless track depicted, that may be used in conjunction with the track-type machine of FIG. 1.

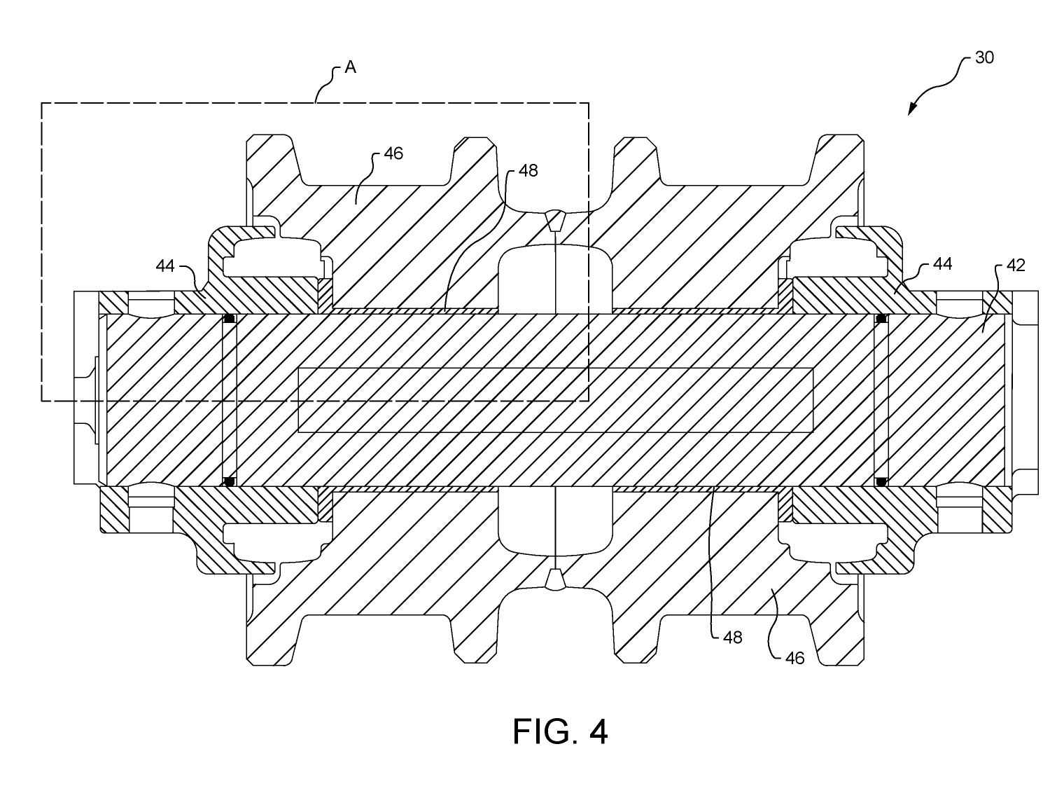

FIG. 4 is a cross-sectional view taken along line 4-4 of FIG. 2 of an exemplary track roller assembly that may be used in conjunction with the track system of FIGS. 2 and 3.

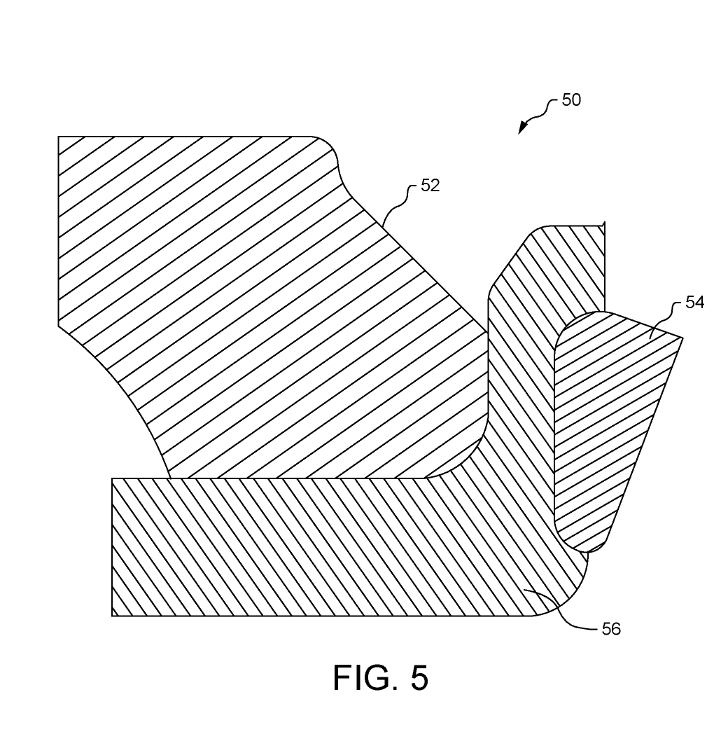

FIG. 5 is a cross-sectional view of a crescent-based track roller seal that may be used in conjunction with the exemplary track roller assembly according to FIG. 4.

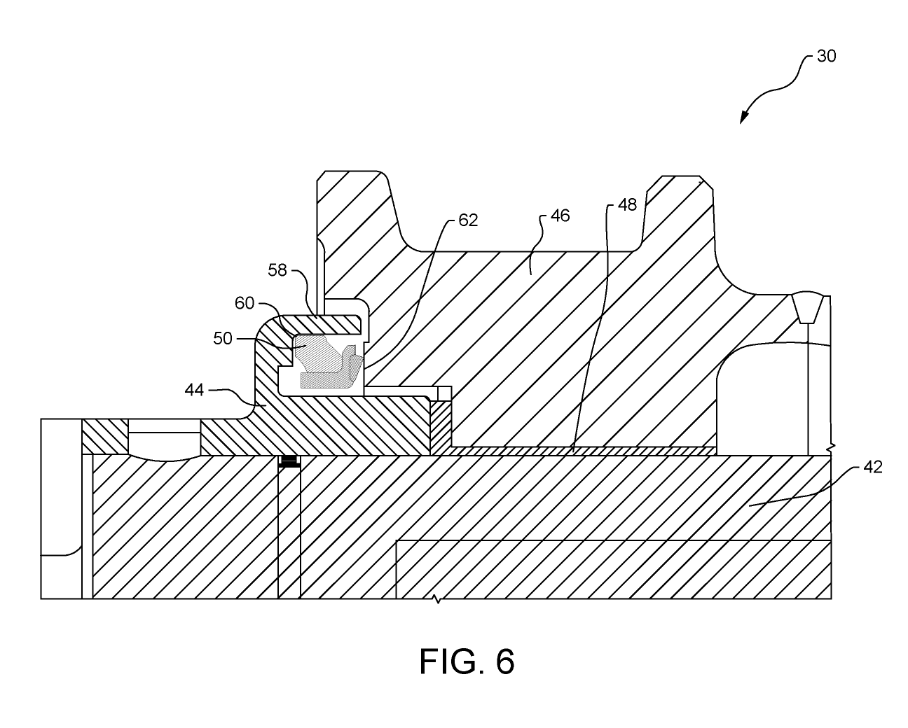

FIG. 6 is an enlarged cross-sectional view of portion A of FIG. 4 depicting an exemplary sealing configuration for a track roller assembly according to one aspect of the present disclosure.

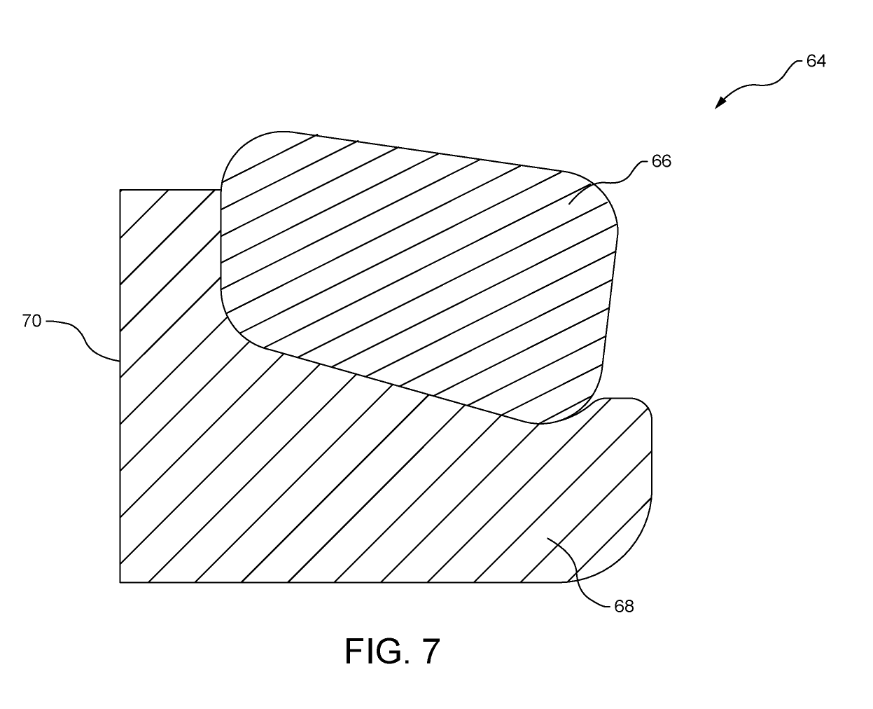

FIG. 7 is a cross-sectional view of a toric-based track roller seal that may be used in conjunction with the exemplary track roller assembly according to FIG. 4.

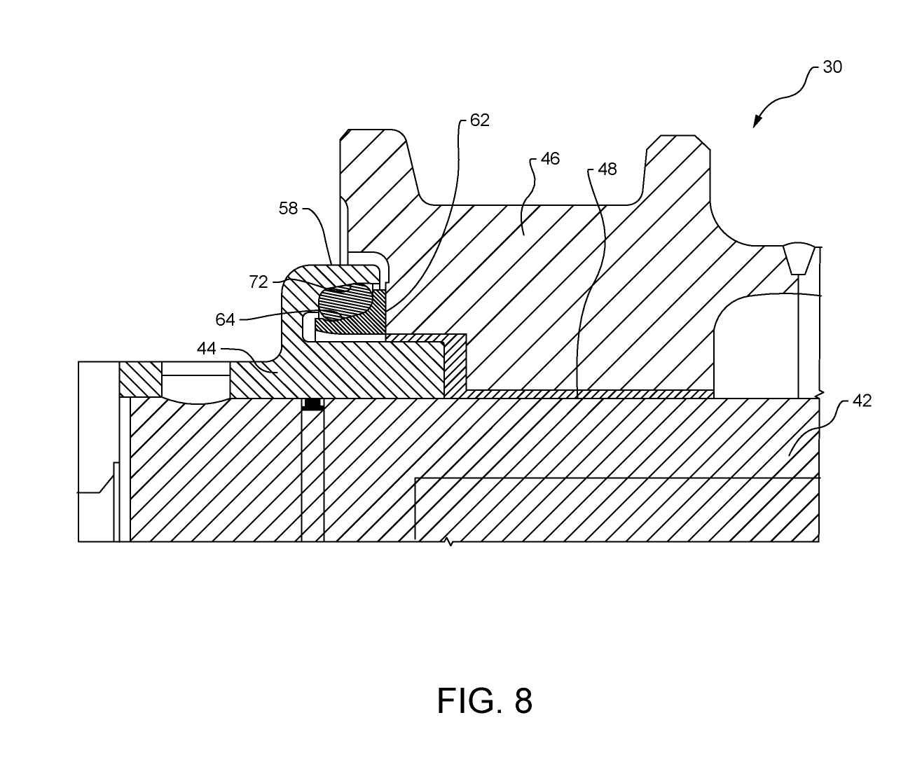

FIG. 8 is an enlarged cross-sectional view of portion A of FIG. 4 depicting an exemplary sealing configuration for a track roller assembly according to another aspect of the present disclosure.

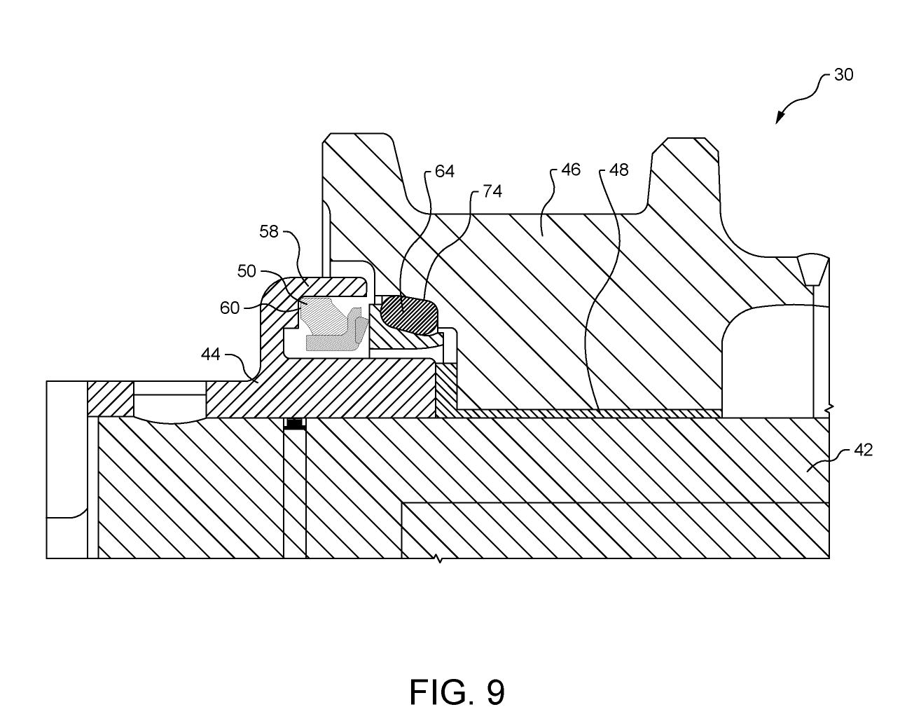

FIG. 9 is an enlarged cross-sectional view of portion A of FIG. 4 depicting an exemplary sealing configuration for a track roller assembly according to another aspect of the present disclosure.

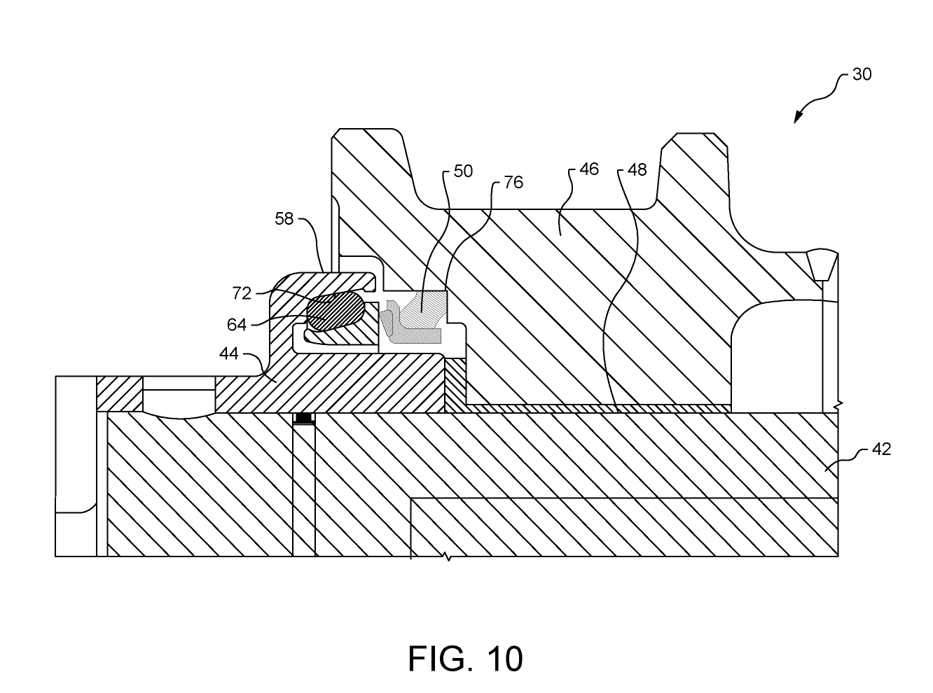

FIG. 10 is an enlarged cross-sectional view of portion A of FIG. 4 depicting an exemplary sealing configuration for a track roller assembly according to another aspect of the present disclosure.

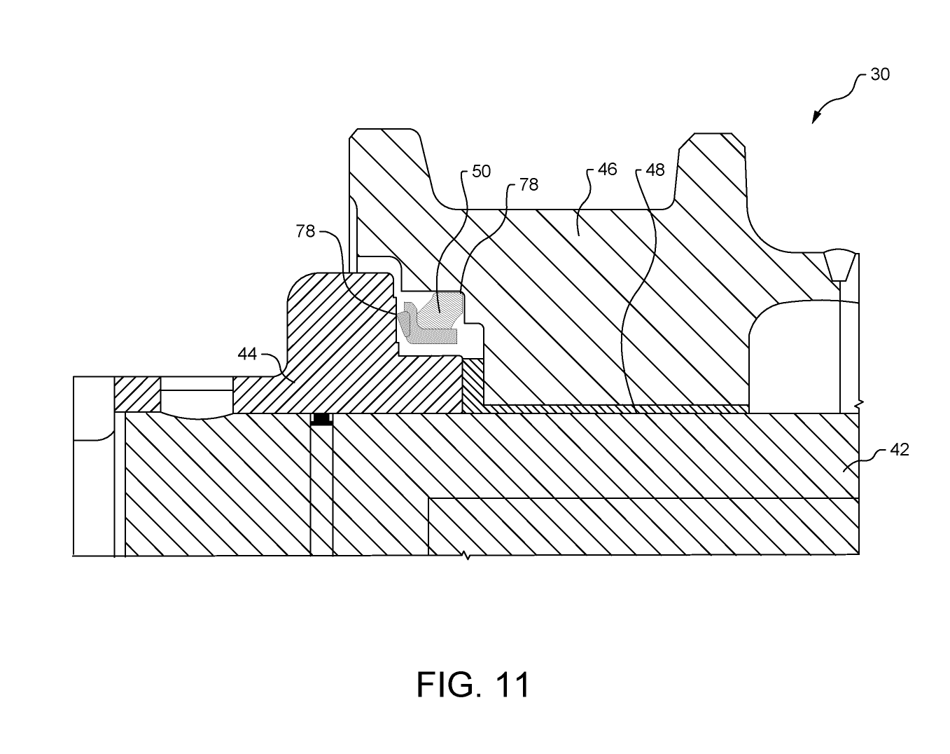

FIG. 11 is an enlarged cross-sectional view of portion A of FIG. 4 depicting an exemplary sealing configuration for a track roller assembly according to another aspect of the present disclosure.

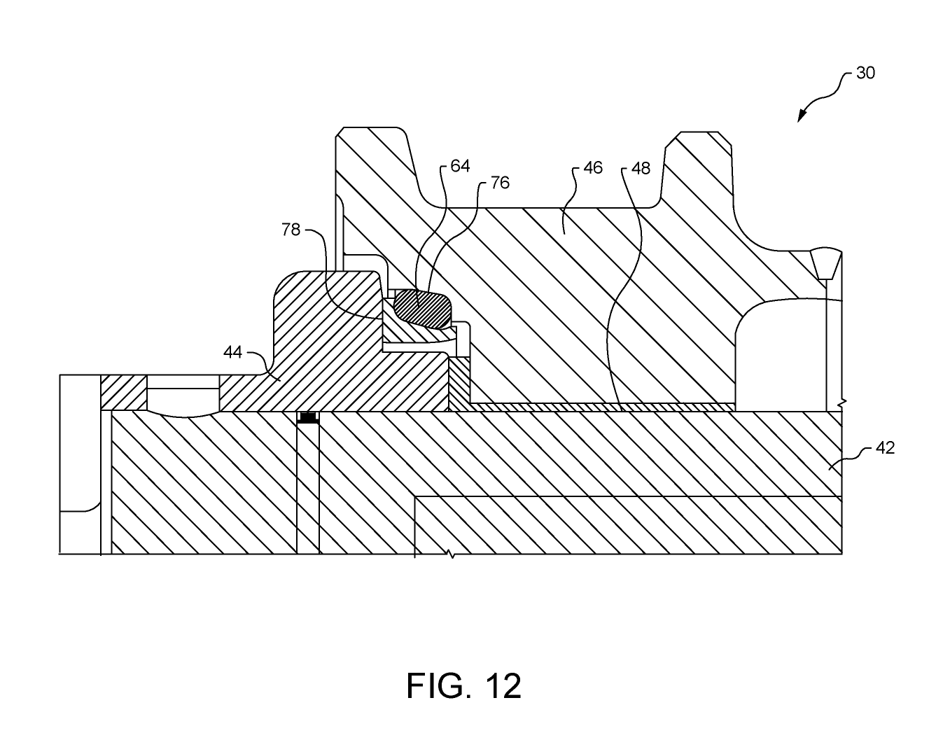

FIG. 12 is an enlarged cross-sectional view of portion A of FIG. 4 depicting an exemplary sealing configuration for a track roller assembly according to another aspect of the present disclosure.

### DETAILED DESCRIPTION OF THE DISCLOSURE

Various aspects of the disclosure will now be described with reference to the drawings, wherein like reference numbers refer to like elements, unless specified otherwise. Referring now to the drawings and with specific reference to FIG. 1, a track-type machine constructed in accordance with the present disclosure is generally referred to by reference numeral 10. The track-type machine 10 may include an operator station 12, a power source 14 for generating power, a work tool or implement 16, and an undercarriage 18 supporting the operator station 12 and the power source 14. The power source 14 may be provided in any number of different forms including, but not limited to, Otto and Diesel cycle internal combustion engines, electric motors, and the like. The track-type machine 10 may further include a track system 20 laterally flanking the track-type machine 10. While the track-type machine 10 illustrated in FIG. 1 is an excavator, this disclosure is also relevant to any other track-type machine 10, including, but not limited to, track-loaders, dozers, skid-steer loaders and the like.

Referring to FIGS. 1-3, the track system 20 may include a track roller frame 22 positioned along a lengthwise-extending direction of the track-type machine 10 and may be pivotably mounted to the undercarriage 18 at a pivot point 24. The track system 20 may further include a drive sprocket 26 that is rotatably driven by the power source 14. The drive sprocket 26 may be located at a first end 28 of the track roller frame 22. Alternatively, in a high-drive system, the drive sprocket 26 may be located above the track roller frame 22 and towards the first end 28 of the track system 20 as is depicted in FIG. 3.

In addition, the track system 20 may include a track roller assembly 30 operatively secured to the track roller frame 22. In one instance the track roller assembly 30 may extend upward from the track roller frame 22. Alternatively, the track roller assembly 30 may extend downward from the track roller frame 22. Additionally, the track system 20 may include a first idler wheel 34 and a second idler wheel 36. When the drive sprocket 26 is located at the first end 28 of the track roller frame 22 as depicted in FIG. 2, the track system 20 may include a first idler wheel 34 positioned at an end of the track roller frame 22 opposite the first end 28. If the drive sprocket 26 is located above the track roller frame 22 towards the first end 28 of the track roller frame 22, such as illustrated in the high-drive system depicted in FIG. 3, the track system 20 may include the first idler wheel 34 located at an end of the track roller frame 22 opposite the first end 28, and may additionally include the second idler wheel 36 located at the first end 28.

Further, the track system 20 may include an endless track 38. The endless track 38 may circumscribe the drive sprocket 26, the track roller assembly 30 and the first idler wheel 34. Similarly, in the high drive system where the drive sprocket 26 is located above the track roller frame 22 towards the first end 28 of the track roller frame 22 as illustrated in FIG. 3, the endless track 38 may also circumscribe the second idler wheel 36. In either instance, the endless track 38 is rotatably engaged with the drive sprocket 26 and transfers the energy of the power source 14 to the ground. Finally, the track system 20 may include an idler yoke assembly 40. As depicted in FIGS. 2-3, the idler yoke assembly 40 is associated with the first idler wheel 34. While not shown, an idler yoke assembly 40 may also be associated with the second idler wheel 36.

Referring now to FIG. 4, a cross-sectional view of the track roller assembly 30 that may be used in conjunction with the track system 20 illustrated in either FIG. 2 or FIG. 3 is depicted. As illustrated, the track roller assembly 30 may include a shaft 42 and a cap 44. The cap 44 may be engaged with the shaft 42. In addition, the shaft 42 may be operatively secured to the track roller frame 22 and may be stationary relative to the track roller frame 22. Additionally, the cap 44 may be immovable relative to the track roller frame 22. Moreover, the track roller assembly 30 may include a roller shell 46. The roller shell 46 may have a through-bore 48 and may be configured to rotate about the shaft 42 when the track-type machine 10 is in motion.

Moving on, FIG. 5 illustrates a cross-sectional view of a crescent-based track roller seal 50 that may be used in conjunction with the track roller assembly 30 according to FIG. 4. The crescent-based track roller seal 50 may include a crescent-shaped load ring 52, a non-metal seal lip 54 and a stiffening-ring 56 positioned between the crescent-shaped load ring 52 and the non-metal seal lip 54. While not intending to be limiting, the crescent-shaped load ring 52 may comprise an abrasion resistant material such as, but not limited to, low-nitrile rubber. The non-metal seal lip 54 may comprise a resilient material such as, but not limited to, thermoplastic urethane. Further, in one instance the stiffening-ring 56 may include a polycarbonate. Alternatively, the stiffening-ring 56 may include a metal.

Referring now to FIG. 6, an enlarged cross-sectional view of portion A of FIG. 4 illustrating an exemplary sealing configuration for the track roller assembly 30 according to one aspect of the present disclosure is shown. As depicted, the cap 44 may further include a collar 58 that may extend both away from the shaft 42 and towards the roller shell 46. Further, the collar 58 may include a collar inner surface 60 configured to sealingly engage the crescent-shaped load ring 52 of the crescent-based track roller seal 50. Further, the roller shell 46 may include a roller shell seal surface 62 configured to rotatably sealingly engage the non-metal seal lip 54 of the crescent-based track roller seal 50. Moreover, in this aspect of the present disclosure, the crescent-based track roller seal 50 may be oriented so that crescent-shaped load ring 52 engages the collar inner surface 60 and the non-metal seal lip 54 engages the roller shell seal surface 62. Additionally and alternatively, the roller shell seal surface 62 may be laser hardened to a Rockwell hardness value of 55 or greater. Alternatively, the roller shell seal surface 62 may be nitrided or carbided to increase its hardness.

Turning to FIG. 7, a cross-sectional view of a toric-based track roller seal that may be used in conjunction with the track roller assembly 30 according to FIG. 4 is depicted and generally referred to by the reference numeral 64. As illustrated, the toric-based track roller seal 64 may include a toric-shaped resilient elastomeric load ring 66 coupled with a metal stiffener ring 68. Further, the metal stiffener ring 68 may further include a ring seal surface 70. The toric-shaped resilient elastomeric load ring 66 may comprise a polymeric material such as, but not limited to, low-nitrile rubber.

Referring now to FIG. 8, an enlarged cross-sectional view of portion A of FIG. 4 is depicted illustrating another exemplary sealing configuration for a track roller assembly 30 manufactured in accordance with the present disclosure. As illustrated, the cap 44 may further include the collar 58 that may extend both away from the shaft 42 and towards the roller shell 46. Further, in this aspect of the present disclosure, the collar 58 may additionally include a collar ramped surface 72 configured to sealingly engage the toric-shaped resilient elastomeric load ring 66 of the toric-based track roller seal 64. Additionally, the roller shell 46 may include the roller shell seal surface 62. In this instance, however, the roller shell seal surface 62 may be configured to rotatably sealingly engage the ring seal surface 70 of the toric-based track roller seal 64. Moreover, in this additional aspect of the present disclosure, the toric-based track roller seal 64 may be oriented so that the toric-shaped resilient elastomeric load ring 66 engages the collar ramped surface 72 and the ring seal surface 70 engages the roller shell seal surface 62. Additionally and alternatively, the roller shell seal surface 62 may be laser hardened to a Rockwell hardness value of 55 or greater. Alternatively, the roller shell seal surface 62 may be nitrided or carbided to increase its hardness.

An additional exemplary sealing configuration for a track roller assembly 30 of the present disclosure is depicted in the enlarged cross-sectional view of portion A of FIG. 4 illustrated in FIG. 9. As illustrated, the track roller assembly 30 may include the crescent-based track roller seal 50. Moreover, the crescent-based track roller seal 50 may have the crescent-shaped load ring 52, the non-metal seal lip 54 and the stiffening-ring 56 positioned between the crescent-shaped load ring 52 and the non-metal seal lip 54. Additionally, the track roller assembly 30 manufactured in accordance with this aspect of the present disclosure may additionally include the toric-based track roller seal 64. The toric-based track roller seal 64 may include the toric-shaped resilient elastomeric load ring 66 coupled with the metal stiffener ring 68. Furthermore, the metal stiffener ring 68 may include the ring seal surface 70. As described above, the crescent-shaped load ring 52 may comprise a polymeric material such as, but not limited to, low-nitrile rubber. Father, the toric-shaped resilient elastomeric load ring 66 may comprise a polymeric material such as, but not limited to, low-nitrile rubber.

Furthermore, in this aspect of the invention the cap 44 may include a collar 58 extending both away from the shaft 42 and towards the roller shell 46 and the collar 58 may have a collar inner surface 60 configured to sealingly engage the crescent-shaped load ring 52. Additionally, the roller shell 46 may further include a roller shell ramped surface 74 configured to sealingly engage the toric-shaped resilient elastomeric load ring 66. In this aspect of the present disclosure, the ring seal surface 70 may be configured to rotatably sealingly engage the non-metal seal lip 54. Moreover, the crescent-based track roller seal 50 may be oriented so that the crescent-shaped load ring 52 engages the collar inner surface 60 and the non-metal seal lip 54 engages the ring seal surface 70. Lastly, in this aspect of the disclosure, the toric-based track roller seal 64 may be oriented so that the ring seal surface 70 engages the non-metal seal lip 54 and the toric-shaped resilient elastomeric load ring 66 engages the roller shell ramped surface 74.

Turning now to FIG. 10, an enlarged cross-sectional view of portion A of FIG. 4 is depicted illustrating another exemplary sealing configuration for a track roller assembly 30 manufactured in accordance with the present disclosure. As shown, the track roller assembly 30 may include the crescent-based track roller seal 50 having the crescent-shaped load ring 52, the non-metal seal lip 54 and the stiffening-ring 56 positioned between the crescent-shaped load ring 52 and the non-metal seal lip 54. Additionally, this configuration may include the toric-based track roller seal 64 having the toric-shaped resilient elastomeric load ring 66 coupled with the metal stiffener ring 68 and the metal stiffener ring 68 may include the ring seal surface 70. As describe before, the crescent-shaped load ring 52 may comprise a polymeric material such as, but not limited to, low-nitrile rubber. Further, the toric-shaped resilient elastomeric load ring 66 may comprise a polymeric material such as, but not limited to, low-nitrile rubber.

Moreover, in this aspect of the present disclosure, the cap 44 may further include the collar 58 extending both away from the shaft 42 and towards the roller shell 46. Additionally, the collar 58 may include a collar ramped surface 72 configured to sealingly engage the toric-shaped resilient elastomeric load ring 66. Furthermore, the roller shell 46 may further include a roller shell inner surface 78 configured to sealingly engage the crescent-shaped load ring 52 and the ring seal surface 70 may be configured to rotatably sealingly engage the non-metal seal lip 54. Additionally, the crescent-based track roller seal 50 may be oriented so that the crescent-shaped load ring 52 engages the roller shell inner surface 78 and the non-metal seal lip 54 engages the ring seal surface 70. Further, the toric-based track roller seal 64 may be oriented so that the ring seal surface 70 engages the non-metal seal lip 54 and the toric-shaped resilient elastomeric load ring 66 engages the collar ramped surface 72.

FIG. 11 is an enlarged cross-sectional view of portion A of FIG. 4 illustrating another exemplary sealing configuration for a track roller assembly 30 manufactured in accordance with the present disclosure. As seen there, the track roller assembly 30 may include the crescent-based track roller seal 50. Like before, the crescent-based track roller seal 50 may have the crescent-shaped load ring 52, the non-metal seal lip 54 and a stiffening-ring 56 positioned between the crescent-shaped load ring 52 and the non-metal seal lip 54. Furthermore, in this configuration, the cap 44 may further include a cap seal surface 80 configured to rotatably sealingly engage the non-metal seal lip 54. In addition, the roller shell 46 may include the roller shell inner surface 78 and be configured to sealingly engage the crescent-shaped load ring 52 and the crescent-based track roller seal 50 may be oriented so that the non-metal seal lip 54 engages the cap seal surface 80 and the crescent-shaped load ring 52 engages the roller shell inner surface 78. Additionally and alternatively, the cap seal surface 80 may be laser hardened to a Rockwell hardness value of 55 or greater. Alternatively, the cap seal surface 80 may be nitrided or carbided to increase its hardness.

Moving on, FIG. 12 is an enlarged cross-sectional view of portion A of FIG. 4 depicting an additional exemplary sealing configuration for a track roller assembly 30 manufactured in accordance with the current disclosure. As shown, this aspect of the disclosure may include the toric-based track roller seal 64 including the toric-shaped resilient elastomeric load ring 66 coupled with the metal stiffener ring 68. Like before, the metal stiffener ring 68 may include the ring seal surface 70. Further, the cap 44 in this aspect of the disclosure may include the cap seal surface 80 and this cap seal surface 80 may be configured to rotatably sealingly engage the ring seal surface 70. Further, the roller shell 46 may include the roller shell ramped surface 74 that may be configured to sealingly engage the toric-shaped resilient elastomeric load ring 66 and the toric-based track roller seal 64 may be oriented so that the ring seal surface 70 engages the cap seal surface 80 and the toric-shaped resilient elastomeric load ring 66 engages the roller shell ramped surface 74. Additionally and alternatively, the cap seal surface 80 may be laser hardened to a Rockwell hardness value of 55 or greater. Alternatively, the cap seal surface 80 may be nitrided or carbided to increase its hardness.

### INDUSTRIAL APPLICABILITY

In general, the present disclosure may find use in many applications including, but not limited to, machines exposed to freeze/thaw cycles during the spring and fall seasons. For example, such machines may include, but are not limited to, track-type machines found in the construction, agricultural and earth-moving industries, such as excavators, bulldozers, track-loaders, skid-steer loaders and the like. Although applicable to any machine exposed to freeze/thaw cycles during the spring and fall seasons, the present disclosure may be particularly applicable to the track roller assembly 30 of a track-type machine 10 exposed to freeze/thaw cycles during the spring and fall seasons. More specifically, the present disclosure finds usefulness by mitigating ingress of contaminants, and lessening egress of lubricant, from the track roller assembly 30 exposed to freeze/thaw cycles during the spring and fall seasons.

In general, the present disclosure may employ the crescent-based track roller seal 50 located between the cap 44 and the roller shell 46 of a track roller assembly 30 to limit contaminant ingress, and lubricant egress, during freeze/thaw cycles. Alternatively, the present disclosure may employ the toric-based track roller seal 64 located between the cap 44 and the roller shell 46 of a track roller assembly 30 to limit contaminant ingress, and lubricant egress, during freeze/thaw cycles. Additionally and alternatively, the present disclosure may employ both the crescent-based track roller seal 50 and the toric-based track roller seal 64, both located between the cap 44 and the roller shell 46, to limit contaminant ingress, and lubricant egress, during freeze/thaw cycles. Furthermore, the present disclosure may employ different configurations of the cap 44, the roller shell 46, orientation of the crescent-based track roller seal 50 between the cap 44 and the roller shell 46 and orientation of the toric-based track roller seal 64 between the cap 44 and the roller shell 46. More specifically, the present disclosure describes and depicts track roller assembly 30 sealing configurations heretofore neither depicted, nor discussed nor suggested by the prior art.

The above description is meant to be representative only, and thus modifications may be made to the embodiments described herein without departing from the scope of the disclosure. Thus, these modifications fall within the scope of present disclosure and are intended to fall within the appended claims.

What is claimed is:

1. A track roller assembly, comprising:
a shaft;
a cap, the cap engaged with the shaft; and
a roller shell configured to rotate about the shaft and having a through-bore.

2. The track roller assembly according to claim 1, further including a crescent-based track roller seal, the crescent-based track roller seal having a crescent-shaped load ring, a non-metal seal lip and a stiffening-ring positioned between the crescent-shaped load ring and the non-metal seal lip, wherein the cap further includes a collar extending both away from the shaft and towards the roller shell, the collar having a collar inner surface configured to sealingly engage the crescent-shaped load ring, wherein the roller shell further includes a roller shell seal surface configured to rotatably sealingly engage the non-metal seal lip and wherein the crescent-based track roller seal is oriented so that the crescent-shaped load ring engages the collar inner surface and the non-metal seal lip engages the roller shell seal surface.

3. The track roller assembly according to claim 1, further including a toric-based track roller seal, the toric-based track roller seal including a toric-shaped resilient elastomeric load ring coupled with a metal stiffener ring, the metal stiffener ring including a ring seal surface, wherein the cap further includes a collar extending both away from the shaft and towards the roller shell, the collar having a collar ramped surface configured to sealingly engage the toric-shaped resilient elastomeric load ring, wherein the roller shell further includes a roller shell seal surface configured to rotatably sealingly engage the ring seal surface and wherein the toric-based track roller seal is oriented so that the toric-shaped resilient elastomeric load ring engages the collar ramped surface and the ring seal surface engages the roller shell seal surface.

4. The track roller assembly according to claim 1, further including a crescent-based track roller seal, the crescent-based track roller seal having a crescent-shaped load ring, a non-metal seal lip and a stiffening-ring positioned between the crescent-shaped load ring and the non-metal seal lip, further including a toric-based track roller seal, the toric-based track roller seal including a toric-shaped resilient elastomeric load ring coupled with a metal stiffener ring, the metal stiffener ring including a ring seal surface, wherein the cap further includes a collar extending both away from the shaft and towards the roller shell, the collar having a collar inner surface configured to sealingly engage the crescent-shaped load ring, wherein the roller shell further includes a roller shell ramped surface configured to sealingly engage the toric-shaped resilient elastomeric load ring, wherein the ring seal surface is configured to rotatably sealingly engage the non-metal seal lip, wherein the crescent-based track roller seal is oriented so that the crescent-shaped load ring engages the collar inner surface and the non-metal seal lip engages the ring seal surface and wherein the toric-based track roller seal is oriented so that the ring seal surface engages the non-metal seal lip and the toric-shaped resilient elastomeric load ring engages the roller shell ramped surface.

5. The track roller assembly according to claim 1, further including a crescent-based track roller seal, the crescent-based track roller seal having a crescent-shaped load ring, a non-metal seal lip and a stiffening-ring positioned between the crescent-shaped load ring and the non-metal seal lip, further including a toric-based track roller seal, the toric-based track roller seal including a toric-shaped resilient elastomeric load ring coupled with a metal stiffener ring, the metal stiffener ring including a ring seal surface, wherein the cap further includes a collar extending both away from the shaft and towards the roller shell, the collar having a collar ramped surface configured to sealingly engage the toric-shaped resilient elastomeric load ring, wherein the roller shell further includes a roller shell inner surface configured to sealingly engage the crescent-shaped load ring, wherein the ring seal surface is configured to rotatably sealingly engage the non-metal seal lip, wherein the crescent-based track roller seal is oriented so that the crescent-shaped load ring engages the roller shell inner surface and the non-metal seal lip engages the ring seal surface and wherein the toric-based track roller seal is oriented so that the ring seal surface engages the non-metal seal lip and the toric-shaped resilient elastomeric load ring engages the collar ramped surface.

6. The track roller assembly according to claim 1, further including a crescent-based track roller seal, the crescent-based track roller seal having a crescent-shaped load ring, a non-metal seal lip and a stiffening-ring positioned between the crescent-shaped load ring and the non-metal seal lip, wherein the cap further includes a cap seal surface configured to rotatably sealingly engage the non-metal seal lip, wherein the roller shell further includes a roller shell inner surface configured to sealingly engage the crescent-shaped load ring and wherein the crescent-based track roller seal is oriented so that the non-metal seal lip engages the cap seal surface and the crescent-shaped load ring engages the roller shell inner surface.

7. The track roller assembly according to claim 1, further including a toric-based track roller seal, the toric-based track roller seal including a toric-shaped resilient elastomeric load ring coupled with a metal stiffener ring, the metal stiffener ring including a ring seal surface, wherein the cap further includes a cap seal surface configured to rotatably sealingly engage the ring seal surface, wherein the roller shell further includes a roller shell ramped surface configured to sealingly engage the toric-shaped resilient elastomeric load ring and wherein the toric-based track roller seal is oriented so that the ring seal surface engages the cap seal surface and the toric-shaped resilient elastomeric load ring engages the roller shell ramped surface.

8. A track system, comprising:
a track roller frame, the track roller frame positioned along a lengthwise-extending direction of a track-type machine;
a drive sprocket, the drive sprocket located at a first end of the track roller frame and rotatably driven by a power source;
a first idler wheel, the first idler wheel rotatably associated with the track roller frame;
a shaft, the shaft operatively secured to the track roller frame and being immovable relative to the track roller frame;
a cap, the cap engaged with the shaft and being stationary relative to the track roller frame;
a roller shell, the roller shell having a through-bore and being configured to rotate about the shaft; and
an endless track, the endless track circumscribing the drive sprocket, the first idler wheel and the roller shell, the endless track being propelled by the drive sprocket and configured to transfer energy of the power source.

9. The track system according to claim 8, further including a crescent-based track roller seal, the crescent-based track roller seal having a crescent-shaped load ring, a non-metal seal lip and a stiffening-ring positioned between the crescent-shaped load ring and the non-metal seal lip, wherein the cap further includes a collar extending both away from the shaft and towards the roller shell, the collar having a collar inner surface configured to sealingly engage the crescent-shaped load ring, wherein the roller shell further includes a roller shell seal surface configured to rotatably sealingly engage the non-metal seal lip, wherein the crescent-based track roller seal is located between the cap and the roller shell and oriented so that the crescent-shaped load ring engages the collar inner surface and the non-metal seal lip engages the roller shell seal surface.

10. The track system according to claim 8, further including a toric-based track roller seal, the toric-based track roller seal including a toric-shaped resilient elastomeric load ring coupled with a metal stiffener ring, the metal stiffener ring including a ring seal surface, wherein the cap further includes a collar extending both away from the shaft and towards the roller shell, the collar having a collar ramped surface configured to sealingly engage the toric-shaped resilient elastomeric load ring, wherein the roller shell further includes a roller shell seal surface configured to rotatably sealingly engage the ring seal surface and wherein the toric-based track roller seal is located between the cap and the roller shell and oriented so that the toric-shaped resilient elastomeric load ring engages the collar ramped surface and the ring seal surface engages the roller shell seal surface.

11. The track system according to claim 8, further including a crescent-based track roller seal, the crescent-based track roller seal having a crescent-shaped load ring, a non-metal seal lip and a stiffening-ring positioned between the crescent-shaped load ring and the non-metal seal lip, further including a toric-based track roller seal, the toric-based track roller seal including a toric-shaped resilient elastomeric load ring coupled with a metal stiffener ring, the metal stiffener ring including a ring seal surface, wherein the cap further includes a collar extending both away from the shaft and towards the roller shell, the collar having a collar inner surface configured to sealingly engage the crescent-shaped load ring, wherein the roller shell further includes a roller shell ramped surface configured to sealingly engage the toric-shaped resilient elastomeric load ring, wherein the ring seal surface is configured to rotatably sealingly engage the non-metal seal lip, wherein the crescent-based track roller seal is located between the cap and the roller shell and oriented so that the crescent-shaped load ring engages the collar inner surface and the non-metal seal lip engages the ring seal surface and wherein the toric-based track roller seal is located between the cap and the roller shell and oriented so that the ring seal surface engages the non-metal seal lip and the toric-shaped resilient elastomeric load ring engages the roller shell ramped surface.

12. The track system according to claim 8, further including a crescent-based track roller seal, the crescent-based track roller seal having a crescent-shaped load ring, a non-metal seal lip and a stiffening-ring positioned between the crescent-shaped load ring and the non-metal seal lip, further including a toric-based track roller seal, the toric-based track roller seal including a toric-shaped resilient elastomeric load ring coupled with a metal stiffener ring, the metal stiffener ring including a ring seal surface, wherein the cap further includes a collar extending both away from the shaft and towards the roller shell, the collar having a collar ramped surface configured to sealingly engage the toric-shaped resilient elastomeric load ring, wherein the roller shell further includes a roller shell inner surface configured to sealingly engage the crescent-shaped load ring, wherein the ring seal surface is configured to rotatably sealingly engage the non-metal seal lip, wherein the crescent-based track roller seal is located between the cap and the roller shell and oriented so that the crescent-shaped load ring engages the roller shell inner surface and the non-metal seal lip engages the ring seal surface and wherein the toric-based track roller seal is located between the cap and the roller shell and oriented so that the ring seal surface engages the non-metal seal lip and the toric-shaped resilient elastomeric load ring engages the collar ramped surface.

13. The track system according to claim 8, further including a crescent-based track roller seal, the crescent-based track roller seal having a crescent-shaped load ring, a non-metal seal lip and a stiffening-ring positioned between the crescent-shaped load ring and the non-metal seal lip, wherein the cap further includes a cap seal surface configured to rotatably sealingly engage the non-metal seal lip, wherein the roller shell further includes a roller shell inner surface configured to sealingly engage the crescent-shaped load ring, wherein the crescent-based track roller seal is located between the cap and the roller shell and wherein the crescent-based track roller seal is oriented so that the non-metal seal lip engages the cap seal surface and the crescent-shaped load ring engages the roller shell inner surface.

14. The track system according to claim 8, further including a toric-based track roller seal, the toric-based track roller seal including a toric-shaped resilient elastomeric load ring coupled with a metal stiffener ring, the metal stiffener ring including a ring seal surface, wherein the cap further includes a cap seal surface configured to rotatably sealingly engage the ring seal surface, wherein the roller shell further includes a roller shell ramped surface configured to sealingly engage the toric-shaped resilient elastomeric load ring, wherein the toric-based track roller seal is located between the cap and the roller shell and wherein the toric-based track roller seal is oriented so that the ring seal surface engages the cap seal surface and the toric-shaped resilient elastomeric load ring engages the roller shell ramped surface.

15. A track-type machine, comprising:
an undercarriage;
a power source supported by the undercarriage;
a track roller frame, the track roller frame positioned along a lengthwise-extending direction of the track-type machine;
a drive sprocket, the drive sprocket located above the track roller frame and rotatably driven by the power source;
a first idler wheel, the first idler wheel rotatably associated with the track roller frame;
a second idler wheel;
a shaft, the shaft operatively secured to the track roller frame and being immovable relative to the track roller frame;
a cap, the cap engaged with the shaft and being stationary relative to the track roller frame;
a roller shell, the roller shell having a through-bore and being configured to rotate about the shaft; and
an endless track, the endless track circumscribing the drive sprocket, the first idler wheel, the second idler wheel and the roller shell, the endless track being propelled by the drive sprocket and configured to transfer energy of the power source.

16. The track-type machine according to claim 15, further including a crescent-based track roller seal, the crescent-based track roller seal having a crescent-shaped load ring, a non-metal seal lip and a stiffening-ring positioned between the crescent-shaped load ring and the non-metal seal lip, wherein the cap further includes a collar extending both away from the shaft and towards the roller shell, the collar having a collar inner surface configured to sealingly engage the crescent-shaped load ring, wherein the roller shell further includes a roller shell seal surface configured to rotatably sealingly engage the non-metal seal lip, wherein the crescent-based track roller seal is located between the cap and the roller shell and oriented so that the crescent-shaped load ring engages the collar inner surface and the non-metal seal lip engages the roller shell seal surface.

17. The track-type machine according to claim 15, further including a toric-based track roller seal, the toric-based track roller seal including a toric-shaped resilient elastomeric load ring coupled with a metal stiffener ring, the metal stiffener ring including a ring seal surface, wherein the cap further includes a collar extending both away from the shaft and towards the roller shell, the collar having a collar ramped surface configured to sealingly engage the toric-shaped resilient elastomeric load ring, wherein the roller shell further includes a roller shell seal surface configured to rotatably sealingly engage the ring seal surface and wherein the toric-based track roller seal is located between the cap and the roller shell and oriented so that the toric-shaped resilient elastomeric load ring engages the collar ramped surface and the ring seal surface engages the roller shell seal surface.

18. The track-type machine according to claim 15, further including a crescent-based track roller seal, the crescent-based track roller seal having a crescent-shaped load ring, a non-metal seal lip and a stiffening-ring positioned between the crescent-shaped load ring and the non-metal seal lip, further including a toric-based track roller seal, the toric-based track roller seal including a toric-shaped resilient elastomeric load ring coupled with a metal stiffener ring, the metal stiffener ring including a ring seal surface, wherein the cap further includes a collar extending both away from the shaft and towards the roller shell, the collar having a collar inner surface configured to sealingly engage the crescent-shaped load ring, wherein the roller shell further includes a roller shell ramped surface configured to sealingly engage the toric-shaped resilient elastomeric load ring, wherein the ring seal surface is configured to rotatably sealingly engage the non-metal seal lip, wherein the crescent-based track roller seal is located between the cap and the roller shell and oriented so that the crescent-shaped load ring engages the collar inner surface and the non-metal seal lip engages the ring seal surface and wherein the toric-based track roller seal is located between the cap and the roller shell and oriented so that the ring seal surface engages the non-metal seal lip and the toric-shaped resilient elastomeric load ring engages the roller shell ramped surface.

19. The track-type machine according to claim 15, further including a crescent-based track roller seal, the crescent-based track roller seal having a crescent-shaped load ring, a non-metal seal lip and a stiffening-ring positioned between the crescent-shaped load ring and the non-metal seal lip, further including a toric-based track roller seal, the toric-based track roller seal including a toric-shaped resilient elastomeric load ring coupled with a metal stiffener ring, the metal stiffener ring including a ring seal surface, wherein the cap further includes a collar extending both away from the shaft and towards the roller shell, the collar having a collar ramped surface configured to sealingly engage the toric-shaped resilient elastomeric load ring, wherein the roller shell further includes a roller shell inner surface configured to sealingly engage the crescent-shaped load ring, wherein the ring seal surface is configured to rotatably sealingly engage the non-metal seal lip, wherein the crescent-based track roller seal is located between the cap and the roller shell and oriented so that the crescent-shaped load ring engages the roller shell inner surface and the non-metal seal lip engages the ring seal surface and wherein the toric-based track roller seal is located between the cap and the roller shell and oriented so that the ring seal surface engages the non-metal seal lip and the toric-shaped resilient elastomeric load ring engages the collar ramped surface.

20. The track-type machine according to claim 15, further including a crescent-based track roller seal, the crescent-based track roller seal having a crescent-shaped load ring, a non-metal seal lip and a stiffening-ring positioned between the crescent-shaped load ring and the non-metal seal lip, wherein the cap further includes a cap seal surface configured to rotatably sealingly engage the non-metal seal lip, wherein the roller shell further includes a roller shell inner surface configured to sealingly engage the crescent-shaped load ring, wherein the crescent-based track roller seal is located between the cap and the roller shell and wherein the crescent-based track roller seal is oriented so that the non-metal seal lip engages the cap seal surface and the crescent-shaped load ring engages the roller shell inner surface.
